(19) United States
(12) Patent Application Publication
(10) Pub. No.: US 2018/0145959 A1
(43) Pub. Date: May 24, 2018

(54) Method for determining access privilege using username, IP address, App ID, App Key, and biometric signature sample.

(71) Applicants: Wayne Taylor, Chandler, AZ (US); Synergex Group, Greenwich, CT (US); Pham Holdings Inc., Lacey, WA (US)

(72) Inventor: Thien Pham, Lacey, WA (US)

(73) Assignees: Synergex Group, Greenwhich, CT (US); Wayne Taylor, Chandler, AZ (US); Pham Holdings, Lacey, WA (US)

(21) Appl. No.: 15/359,504

(22) Filed: Nov. 22, 2016

(51) Int. Cl. H04L 29/06

(52) U.S. Cl. CPC H04L 63/083; H04L 63/0861

(57) ABSTRACT

Method for determining access privilege using username, IP address, App ID, App Key, and biometric signature sample.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to a computer program that determines the access privilege using a username, IP address, App ID, App Key, and biometric signature sample.

### BACKGROUND OF THE INVENTION

Computer hacking continues to be a major problem for all companies offering software as a service. To protect the software as a service, companies implement username and password. The problem with username and password is that it is hackable using sophisticated malware that captures user keystrokes and transmit that information to the creator of the malware. The information is then use to gain access to user's email accounts, financial accounts, and other online accounts. The hacker can also use the stolen information to conduct financial transactions or sell the stolen information for financial gain.

What is needed is a method for determining access privilege using username, IP address, App ID, App Key, and biometric signature sample.

### BRIEF SUMMARY OF THE INVENTION

In a typical application, a user accesses software as a service through a web browser such as Microsoft Internet Explorer, Apple Safari, and Mozilla Firefox. Another method of access is through an application running on a device. The user enters his/her username and clicks the submit button to begin. The application then submits the username, IP address of the network router that the application running on the device is connected to, the App Key, the App ID, and biometric signature sample to the present invention. When the present invention receives the required information, the present invention validates the information and returns to the requesting application a response. The requesting application then uses the response to take the necessary actions.

### BRIEF DESCRIPTION OF THE SEVERAL VIEWS OF THE DRAWING

FIG. 1 illustrates an exemplary environment for authenticating a user.

FIG. 2 illustrates the method for determining access privilege using username, IP address, App ID, App Key, and biometric signature sample.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

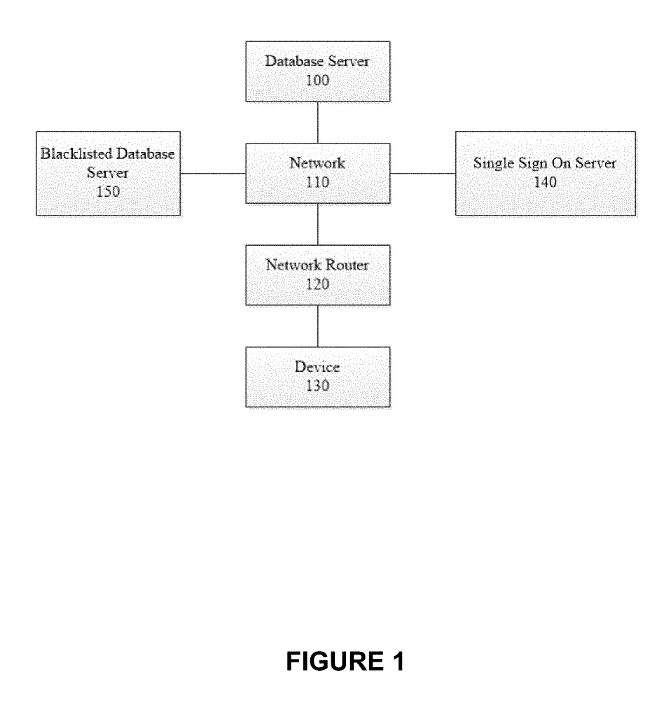

FIG. 1 illustrates an exemplary environment in which the requesting application runs on device 130. Device 130 is coupled to single sign on server 140 via the network router 120 and network 110. Single sign on server 140 is coupled to database server 100 via network 110. Single sign on server 140 is coupled to blacklisted database server 150 via the network 110. The present invention runs on the single sign on server 140.

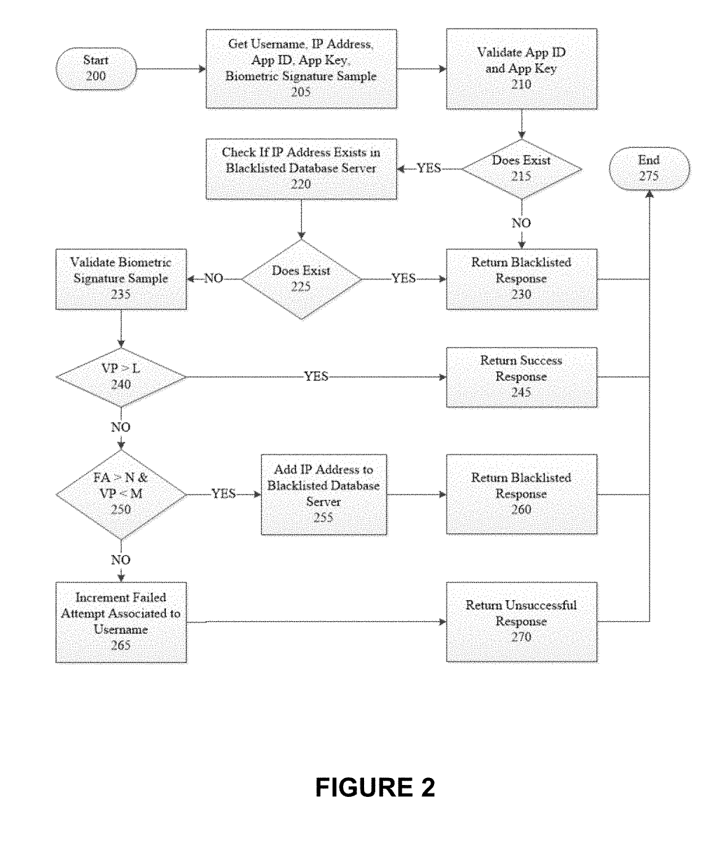

FIG. 2 illustrates the method for determining access privilege using username, IP address, App ID, App Key, and biometric signature sample. When the requesting application running on device 130 connects to the single sign on server 140 via the network router 120 and the network 110 to conduct a validation request by submitting the username, IP address, App ID, App Key, and biometric signature sample, the present invention, which is a computer program, starts at Step 200 and continues to Step 205. At Step 205, the program receives the username, IP address, App ID, App Key, and biometric signature sample and continues to Step 210. At Step 210, the program validates the App ID and the App Key by connecting to the database server 100 via the network 110 to see if the App ID and App Key exist in the database server 100 and continues to Step 215. If at Step 215 the App ID and/or App Key do not exist in database server 100, the program continues to Step 230. At Step 230, the program returns to the requesting application a Blacklisted response and continues to Step 275 where the program ends. If at Step 215, the App ID and App Key do exist, the program continues to Step 220. At Step 220, the program connects to the blacklisted database server 150 via the network 110 and checks if the IP address exists and continues to Step 225. If at Step 225 the IP address does exist in the blacklisted database server 150, the program continues to Step 230 where it returns a Blacklisted response to the requesting application and continues to Step 275 where it ends. If at Step 225 the IP address does not exist in the blacklisted database server 150, the program continues to Step 235. At Step 235, the program validates the biometric signature sample using a biometric signature verification program and continues to Step 240. The biometric signature verification program returns a percentage of accuracy VP of the biometric signature sample to a set of biometric signature samples. VP is greater than or equal to 0 and less than or equal to 100. L is greater than or equal to 0 and less than or equal to 100. The biometric signature sample is not limited to facial, finger print, voice, or signature drawn by the movement of a computer mouse, finger, or digitizer tablet. At Step 240, if VP is greater than L, the program continues to Step 245 where it returns a Success response to the requesting application and continues to Step 275 where it ends. If at Step 240, VP is less than or equal to L, the program continues to Step 250. At Step 250, the program checks the number of failed attempts FA is greater than N and validation percentage VP is less than M. N is greater than 0 and is a predefined number. M is greater than 0 and is a predefined number. VP is greater than or equal to 0 and less than or equal to 100. FA is greater than or equal to 0. If at Step 250 FA is greater than N and VP is less than M, then the program continues to Step 255 where the program connects to blacklisted database server 150 via the network 110 and adds the IP address to the blacklisted database server 150 and continues to Step 260. At Step 260, the program returns a Blacklisted response to the requesting application. If at Step 250 FA is less than or equal to N and VP is greater than or equal to M, the program continues to Step 265. At Step 265, the program connects to database server 100 via the network 110 and increments the failed attempt associated to the username of Step 205 and continues to Step 270. At Step 270, the program returns an Unsuccessful response to the requesting application and continues to Step 275 where the program ends.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method for determining access privilege comprising the steps of:
(a) getting the username, IP address, App ID, App Key, and biometric signature sample
(b) checking the App ID and App Key exist in the database server
(c) checking if the IP address exists in a blacklisted database server
(d) checking if the biometric signature sample with a biometric signature verification program which returns a verification percentage VP is greater than a predefined percentage L
(e) adding the IP address to the blacklisted database server if failed attempt FA is greater than a predefined fail attempt N and verification percentage VP is less than a predefined percentage M
(f) incrementing failed attempt associated to the username of Step (a)
(g) returning a response to the verification of the data of Step (a)

2. The method of claim 1, wherein the program returns a Blacklisted response if the App ID and/or App Key do not exist in the database server

3. The method of claim 1, wherein the program returns a Blacklisted response if the IP address exists in the blacklisted database server

4. The method of claim 1, wherein the program returns a Success response if the biometric signature verification percentage VP is greater than a predefined percentage L

5. The method of claim 1, wherein the biometric signature sample is not limited to facial, voice, finger print, or signature generated by the movement of a computer mouse, finger or digitizer tablet

6. The method of claim 1, wherein VP and L are greater than or equal to 0 and less than or equal to 100

7. The method of claim 1, wherein FA is greater than 0, N is greater than 0, and M is greater than or equal to 0 and less than or equal to 100
